(19) United States
(12) Patent Application Publication
(10) Pub. No.: US 2009/0009800 A1
(43) Pub. Date: Jan. 8, 2009

(54) IMAGE FORMING APPARATUS AND IMAGE FORMING METHOD

(75) Inventor: Eun-hui Jung, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/147,664

(22) Filed: Jun. 27, 2008

(30) Foreign Application Priority Data
Jul. 4, 2007 (KR) 2007-67273

(51) Int. Cl. G06F 3/12

(52) U.S. Cl. 358/1.15; 358/1.16

(57) ABSTRACT

An image forming apparatus includes an image forming unit to form an image based on input printing data, a storage unit to store history information of the printing data therein, and a controller to determine whether the inputted printing data is already printed already by using the history information, and to control the image forming unit not to form the image with the printing data already used to form the image among the input printing data if it is determined that the printing data is already printed.

### CROSS-REFERENCE TO RELATED APPLICATIONS

This application claims priority under 35 U.S.C. §119(a) from Korean Patent Application No. 10-2007-0067273, filed on Jul. 4, 2007 in the Korean Intellectual Property Office, the disclosure of which is incorporated herein in its entirety by reference.

### BACKGROUND OF THE INVENTION

1. Field of the Invention

The present general inventive concept relates to an image forming apparatus and an image forming method, and more particularly, to an image forming apparatus which forms an image with printing data of a failed operation to form an image, and an image forming method thereof.

2. Description of the Related Art

An image forming apparatus forms an image based on printing data. If requested to form an image with the printing data, the image forming apparatus forms an image per job that is requested.

A conventional image forming apparatus stores the requested printing data in a storage unit such as a hard disk, and forms an image based on the stored printing data. Then, the conventional image forming apparatus extracts user information and identification information such as a file name to identify the printing job from the stored printing data.

In some cases, the image may not be completely formed with the printing data during an image forming process of the printing job due to cancellation of a user, etc. If a user requests the failed job again, the conventional image forming apparatus repeatedly stores the requested printing data in the storage unit and forms an image. Thus, a problem arises that the printing data which is already used to form an image is repeatedly printed.

### SUMMARY OF THE INVENTION

The present general inventive concept provides an image forming apparatus which determines whether input printing data is equivalent to printing data already used to form an image and does not form an image with the printing data already used to form the image, and prevents repetitive printing even if the equivalent printing data is requested to be printed again, and an image forming method.

The present general inventive concept also provides an image forming apparatus which does not form an image with printing data already used to form an image, and reduces consumption of the consumables such as record media and toner, and an image forming method.

The present general inventive concept also provides an image forming apparatus which prevents inconvenience that a user individually controls printing data not to print repeatedly, and an image forming method.

The present general inventive concept also provides an image forming apparatus which compares printing data even if the printing data already used to form an image does not include identification information, and prevents repetitive printing, and an image forming method thereof.

Additional aspects of the present general inventive concept will be set forth in part in the description which follows and, in part, will be obvious from the description, or may be learned by practice of the present general inventive concept.

The foregoing and/or other aspects of the present general inventive concept can be achieved by providing an image forming apparatus, including an image forming unit to form an image based on input printing data, a storage unit to store history information of the printing data therein, and a controller to determine whether the input printing data is already printed by using the history information, and to control the image forming unit not to form the image with the printing data already used to form the image among the input printing data if it is determined that the printing data is printed already.

The controller may determine whether the input printing data is already printed by comparing identification information of the printing data.

The identification information may include at least one of user information requesting to form the image, a file name of the printing data, a file size of the printing data, and succeeded/failed page information regarding forming the image.

The storage unit may store the succeeded/failed printing data regarding forming the image.

The controller may compare the input printing data with the failed printing data and determines whether the input printing data is already printed if the printing data does not include identification information.

The controller may display the printed page information among the failed printing data.

The controller may receive an input whether to print the failed printing data, and forms the image.

The controller may store the information of the printing data already used to form the image, per page in the storage unit.

The controller may store the information of the printing data already used to form the image, per page in the storage unit.

The printing data may include at least two files.

The foregoing and/or other aspects of the present general inventive concept can also be achieved by providing an image forming method, including storing history information on printing data, determining whether the printing data is already printed by using the history information, and not forming an image with printing data already used to form the image among the input printing data if it is determined that the printing data is printed already.

The determining of whether the printing data is printed already may include determining whether the printing data is already printed by using identification information of the printing data.

The identification information may include at least one of user information requesting to form an image, a file name and a file size of the printing data, and succeeded/failed page information regarding forming the image.

The storing of the history information may include storing the succeeded/failed printing data regarding forming the image.

The determining of whether the printing data is already printed may include comparing the input printing data with the failed printing data and determining whether the input printing data is already printed if identification information of the printing data does not exist.

The determining of whether the inputted printing data is already printed may further include displaying printed page information among the failed printing data.

The displaying of the printed page information may further include receiving an input whether to print the failed printing data.

The storing of the history information may include storing the information on the printing data already used to form the image, per page.

The storing of the history information includes storing the information on the printing data already used to form the image, per page.

The printing data may include at least two files.

The foregoing and/or other aspects of the present general inventive concept can also be achieved by providing an image forming apparatus including an image forming unit to form an image on a print medium according to printing data, and a control unit to generate a signal representing history information of the printing data to correspond to a first portion of the printing data that is used to form the image, and to correspond to a second portion of the printing data that is not used to form the image.

The foregoing and/or other aspects of the present general inventive concept can also be achieved by providing an image forming apparatus including an image forming unit to form an image on a print medium according to printing data, and a control unit to generate a signal representing history information of the printing data to correspond to the printing data that is not used to form the image in a page unit.

The foregoing and/or other aspects of the present general inventive concept can also be achieved by providing an image forming apparatus, including an image forming unit to form a first image according to a first portion of printing data and not to form a second image according to a second portion of the printing data, a storage unit to store history information of the printing data including first information on the first portion of the printing data and second information on the second portion of the printing data, and a controller to determine whether information on input printing data to be formed as a third image is substantially same as the history information of the printing data, and to control the image forming unit not to form the first image with the first portion of the printing data and to form the second image according to the determination.

The first image and the second image may be formed in a page unit, and the controller may generate a signal representing the history information of the printing data in the page unit.

The image forming unit may render the printing data to correspond to the first image and the second image in the page unit.

The image forming unit may render the input printing data to correspond to the third image, and the controller may determine whether the information of the third image of the input printing data is the same ad the history information of the first image and the second image of the printing data.

### BRIEF DESCRIPTION OF THE DRAWINGS

The above and/or other aspects of the present general inventive concept will become apparent and more readily appreciated from the following description of the embodiments, taken in conjunction with the accompany drawings of which:

FIG. 1 is a block diagram illustrating an image forming apparatus according to an embodiment of the present general inventive concept;

FIG. 2 is a block diagram illustrating a controller of the image forming apparatus of FIG. 1 according to an embodiment of the present general inventive concept;

FIG. 3 illustrates an interface which displays a printing status of a failed job of the image forming apparatus of FIG. 1 according to an embodiment the present general inventive concept;

FIG. 4A illustrates a process of determining whether printing data are equivalent to each other by an image forming apparatus according to an exemplary embodiment of the present general inventive concept;

FIG. 4B illustrates a process of determining whether printing data are equivalent to each other by an image forming apparatus according to an exemplary embodiment of the present general inventive concept;

FIG. 5 is a flowchart illustrating an image forming method according to an embodiment of the present general inventive concept; and

FIG. 6 is a detailed flowchart illustrating an image forming method according an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

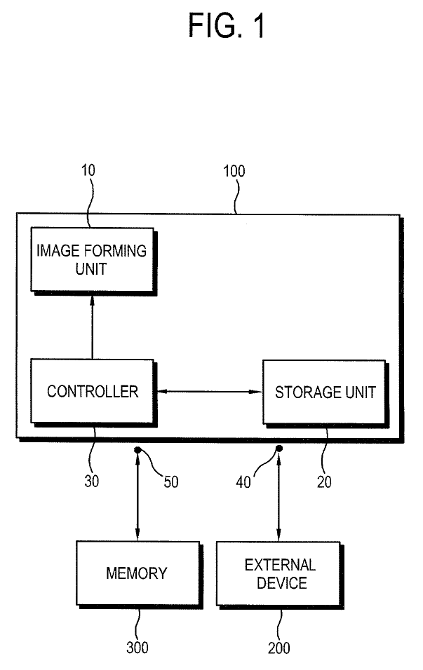

FIG. 1 is a block diagram illustrating an image forming apparatus 100 according to an embodiment of the present general inventive concept. Referring to FIG. 1, the image forming apparatus 100 according to the present general inventive concept includes an image forming unit 10, a storage unit 20 and a controller 30.

The image forming apparatus 100 may receive printing data from a host computer 200 through a port 40 or from a memory 300 through a port 50 such that the control unit 30 controls the image forming unit 10 to perform a printing operation of feeding a record medium, printing the printing data on the record medium, and discharging the record medium outside the image forming apparatus 100.

The image forming unit 10 forms an image based on input printing data. The image forming unit 10 according to the present general inventive concept may further include a rendering module which performs data-rendering to print the printing data on a record medium. The image forming unit 10 according to the present general inventive concept may include a photosensitive body (not illustrated) which forms an electrostatic latent image thereon, a developing unit (not illustrated) which develops a developer to the photosensitive body, and a transfer unit (not illustrated) which transfers the developer developed to the photosensitive body to a printing paper to form an image.

The image forming unit 10 may be an inkjet image forming unit having an ink-jet printhead unit to form an image on a printing paper using an inkjet printing method. The image forming unit 10 may further include a paper feeding unit to feed the printing paper toward the transfer unit or the ink-jet printhead unit, and a discharge unit to discharge the printing paper with the image.

The storage unit 20 stores history information of the printing data therein. The history information may include identification information to identify an image forming job of the printing data. If the printing data is received and direct-printed from the memory 50 through the port 50, for example, a universal serial bus (USB) port, the identification information may not be stored. The identification information may include information on a user requesting the printing operation, and a file name of the printing data as well as an operation ID.

If the direct printing is performed, the storage unit 20 may store the printing data without the identification information so that the controller 30 may determine whether input printing data is equivalent to the printing data already used to form an image.

The storage unit 20 according to the present general inventive concept may include a hard disk drive (HDD), but not limited thereto. Alternatively, the storage unit 20 may include a flash memory as long as it stores the history information and/or the printing data therein.

The controller 30 determines whether the printing data is already printed by using the history information stored in the storage unit 20. If it is determined that the printing data is already printed, the controller 30 controls the image forming unit 10 not to form an image with the printing data already used to form the image among the inputted printing data.

The printing data may include first printing data to correspond to one or more first pages as the image of a first printing job, and second printing data to correspond to one or more second pages as the image of a second printing job. When at least one of the first pages of the first printing data and/or at least one of the second pages of the second printing data are not printed due to any interruption of each printing operation, for example, cancellation of the printing job, the incompleteness of the printing job and information on printed pages and/or unprinted pages of the first and/or second printing jobs may be included in the history information.

When third printing data is input as the input printing data, and the third printing data corresponds to one or more third pages as an image of a third printing job, information on the third pages of the third printing data is compared with first history information of the first printing data of the first printing job and/or second history information of the second printing data of the second printing job, and according to the comparison, it is determined whether the third printing data of the third printing job is similar to or the same as the first printing data of the first printing job or the second printing data of the second printing job.

Accordingly, the controller 30 controls the image forming unit 10 to prevent printing of the printed first pages of the first printing data and to print the unprinted first pages of the first printing data if the third printing data of the third printing job is similar to or the same as the first printing data of the first printing job. The controller 30 can control the image forming unit 10 to prevent printing of the printed second pages of the second printing data and to print the unprinted second pages of the second printing data if the third printing data of the third printing job is similar to or the same as the second printing data of the second printing job.

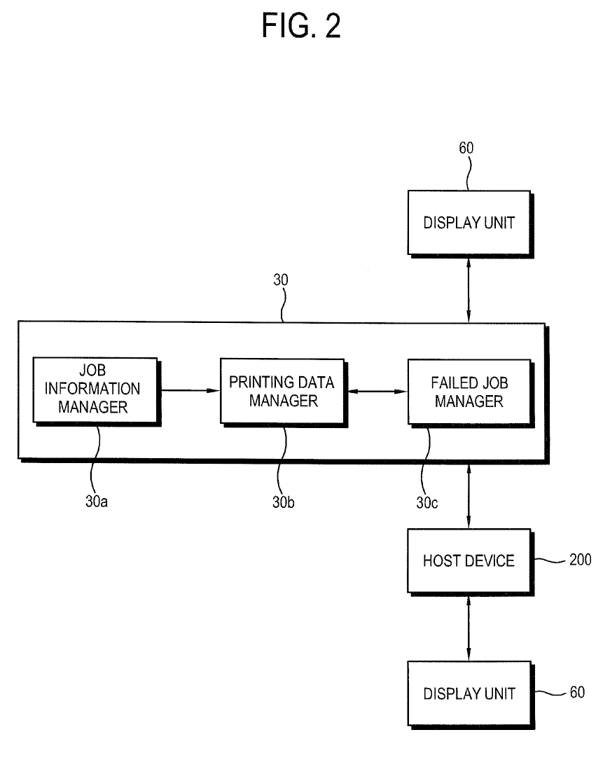

Hereinafter, the controller 30 according to the present general inventive concept will be described in more detail with reference to FIG. 2.

Referring to FIGS. 1 and 2, the controller 30 according to the present general inventive concept includes a job information manager 30a, a printing data manager 30b and a failed job manager 30c.

The job information manager 30a extracts the identification information of the job from the printing data, and stores the extracted identification information in the storage unit 20.

The history information may include information on the printing data and/or the printing job, the number of pages (or page numbers) of the printing data printed during the printing operation of the printing job, and/or the number of pages (or page numbers) of the printing data not printed during the printing operation.

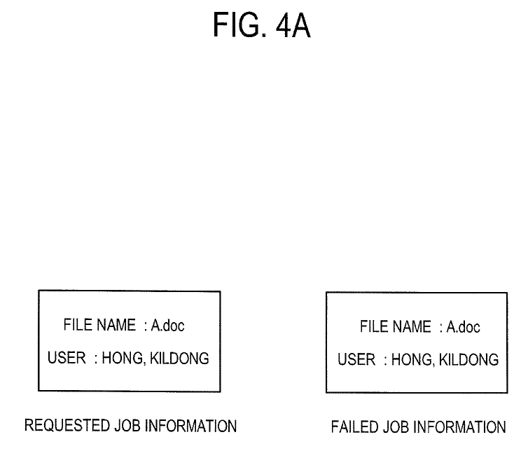

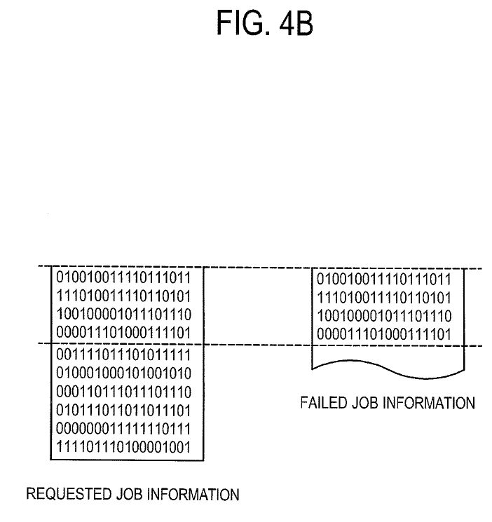

The printing data manager 30b stores the requested printing data in the storage unit 20 and removes the printing data therefrom, and determines whether the input printing data is equivalent to the printing data already used to form the image. The process of determining equivalence of the printing data will be described later with reference to FIGS. 4A and 4B.

If the printing data of a new printing job is requested to be printed, the failed job manager 30c determines whether the requested printing data of the new printing job is equivalent to the printing data already used to form an image. If it is determined that the requested printing data is equivalent to the printing data already used to form an image, the failed job manager 30c determines that the failed job is requested again as the new printing job, and controls the image forming unit 10 not to form an image with the printing data already used to form an image and to form an image with only the remaining printing data. More specifically, the failed job manager 30c emulates the requested printing data and generates page information of the printing data. The failed job manager 30c compares the generated page information with information on pages that are successfully printed, and may form an image with the remaining printing data only. The remaining printing data may be one or more pages which have not been printed in the previous printing job.

If the storage unit 20 stores only identification information of the job instead of the printing data, the failed job manager 30c determines equivalence of the printing data with the information on a user requesting the printing data to form an image, a file name of the printing data, and a file size of the printing data. The file size may be a total number of pages of the printing data. The failed job manager 30c emulates the input printing data and generates the page information, thereby forming an image with the remaining printing data only.

The controller 30 may be directly connected to a display unit 60 or connected to the display unit 60 through the external host device 200. It is possible that the control unit 30 may be installed in the host device 200 to communicate with the image forming unit 10, the storage unit 20, and the display unit 60.

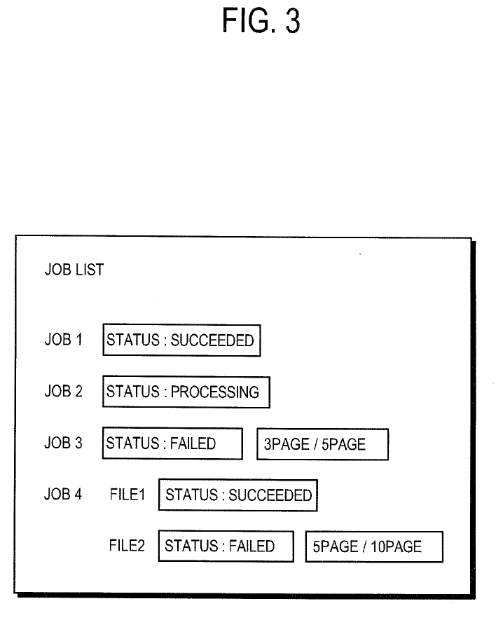

FIG. 3 illustrates an interface to display a printing status of the failed job of the image forming apparatus 100 according to the present general inventive concept. Referring to FIGS. 1, 2, and 3, the failed job manager 30c generates a signal to display on the display unit 60 an image (an interface) including “Job 1” and “succeeded” if “Job 1” is successfully performed, and “Job 2” and “processing” if “Job 2” is being performed. If “Job 3” having total five pages to print is failed, after first three pages are printed, the failed job manager 30c displays “Job 3” and “failed”, and displays that the first three pages of the “Job 3” are successfully printed. The interface illustrated in FIG. 3 may be displayed as a spooler or an additional UI. The failed job manager 30c may store the respective jobs and printing status in the storage unit 20.

The failed job manager 30c may receive a user's input whether to print the failed job. If a user selects to print the failed job, the failed job manager 30c may control the image forming unit 10 to form an image with the remaining printing data. Thus, a user may recognize easily whether the requested printing data is the printing data failed to form an image, and determine whether to print the failed printing data.

The failed job manager 30c may store only the status of the failed job in the storage unit 20 instead of storing the status of the succeeded job.

If the printing data requested as a single job includes two or more files, the controller 30 extracts the identification information of the job from the requested file, and compares the extracted identification information with the identification information pre-stored in the storage unit 20 to determine whether the requested file is already printed. If it is determined that the requested file is not printed, the controller 30 controls the image forming unit 10 to form the image. If the job is failed while being performed, the controller 30 stores the page information on the pages that are successfully printed.

For example, as illustrated in FIG. 3, two files which respectively have 10 pages are requested as a single job. If the printing job is failed after the file 1 is printed and the first five pages of the file 2 are printed, the controller 30 stores the failed job and the 15 pages that are successfully printed, in the storage unit 20. If the file is requested again to print, the controller 30 may control the image forming unit 10 to resume forming the image from the sixteenth pages, i.e., the sixth page of the file 2 based on the information stored in the storage unit 20. The failed job manager 30c according to the present general inventive concept recognizes the two or more files as respective pages to emulate, and may not form an image with the already-printed page even if the single job includes the two or more files.

Hereinafter, the process of determining whether the input printing data is equivalent to the printing data already used to form an image by the image forming apparatus 100 according to the present general inventive concept will be described with reference to FIGS. 4A and 4B.

FIG. 4A illustrates a method of determining the equivalence of the printing data with the identification information of the printing data by the image forming apparatus 100 according to an exemplary embodiment of the present general inventive concept. Referring to FIGS. 1 through 4A, the inputted printing data includes the file name of the printing data and the user information requesting to form the image, as the identification information. If the file name and the user information included in the inputted printing data as the identification information is equivalent to those of the printing data stored in the storage unit 20, the printing data manager 30b determines that the printing data failed to form an image is requested again. Thus, the image forming unit 10 may form an image with the remaining printing data among the input printing data instead of forming the image with the printing data already used to form image. The printing data manager 30b transmits the page information to form an image to the image forming unit 10 so that the image is formed with the remaining printing data only. Here, the identification information may include the file size of the printing data and the succeeded/failed page information regarding forming an image as well as the file name of the printing data.

FIG. 4B illustrates a method of determining whether the inputted printing data is equivalent to the printing data already used to form an image by comparing the printing data themselves by the image forming apparatus 100 according to an exemplary embodiment of the present general inventive concept.

If the printing data is direct-printed through the USB port or the like, the printing data does not include the identification information of the job. As shown in FIG. 4B, the printing data manager 30b compares the inputted printing data with the printing data stored in the storage unit 20. Here, the printing data manager 30b may compare the two printing data as much as the failed amount of the printing data, and compare the printing data per bit and determine the equivalence of the two printing data.

If it is determined that the two printing data are equivalent, the printing data manager 30b may control the image forming unit 10 to form the image with the printing data only stored in the storage unit 20.

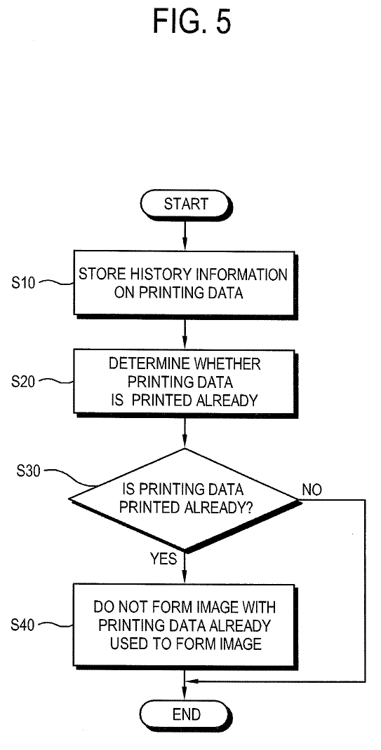

Hereinafter, the image forming method of FIG. 4A according to the embodiment of the present general inventive concept will be described with reference to FIG. 5.

Referring to FIGS. 4A and 5, the controller 30 stores the history information on the printing data in the storage unit 20 at operation S10. The controller 30 determines whether the printing data is already printed by using the stored history information at operation S20.

According to the embodiment of FIG. 4A, the identification information of the input printing data is compared with the identification information of the printing data already used to form an image at operation S20 to determine whether the inputted printing data is already printed. According to the embodiment of FIG. 4B, the failed printing data is compared with the inputted printing data to determine whether the inputted printing data is already printed.

The operation S20 may further include an operation to generate a signal to display the printed page information among the failed printing data. The operation of displaying the printed page information may further include an operation which receives an input whether to print the failed printing data. Thus, a user may acknowledge easily whether the requested data is the failed printing data, and determine whether to print the failed printing data.

If it is determined at operation S20 that the inputted printing data is printed already, the controller 30 controls the image forming unit 10 to form an image with only the remaining printing data among the inputted printing data, instead of forming an image with the printing data already used to form an image at operation S30.

Thus, the repetitive printing may be prevented even if the printing data already used to form an image is requested again.

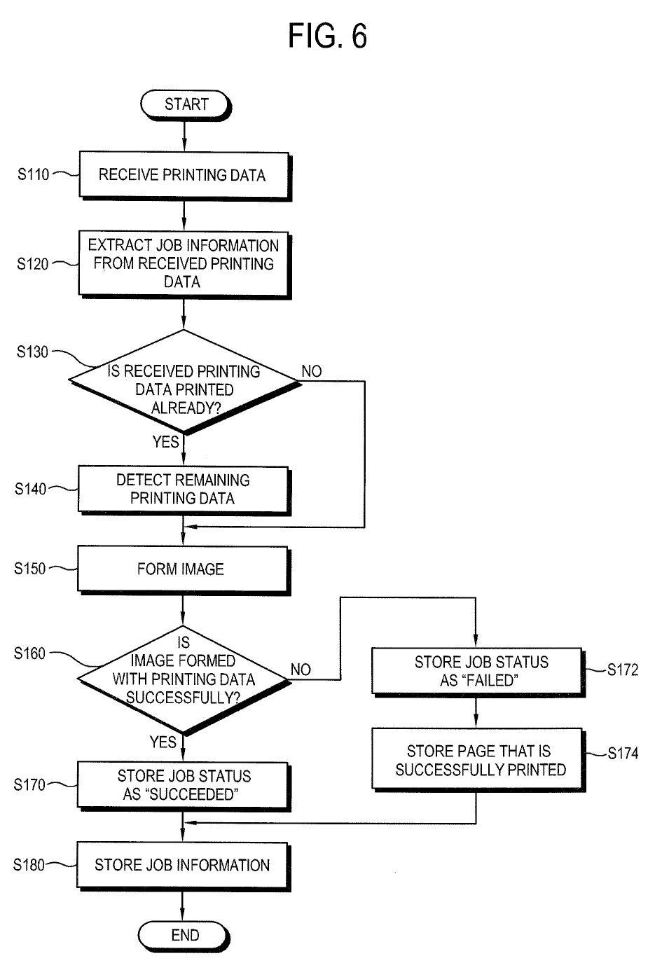

Hereinafter, the image forming method of FIG. 4A according to the exemplary embodiment of the present general inventive concept will be described in more detail with reference to FIG. 6.

If the printing data is inputted at operation S110, the controller 30 extracts the identification information of the job from the inputted printing data at operation S120.

The controller 30 determines whether the printing data inputted at operation S110 is equivalent to the printing data already used to form an image at operation S130. If it is determined at operation S130 that the inputted printing data is equivalent to the printing data already used to form an image, the controller 30 extracts the remaining printing data at operation S1 40, and controls the image forming unit 10 to form an image with the extracted remaining printing data only at operation S150.

The controller 30 determines whether the image is successfully formed with the printing data at operation S160, and stores the job status as “succeeded” if it is determined that the image is successfully formed at operation S170. If it is determined that the image is not successfully formed, the controller 30 stores the job status as “failed” at operation S172), and stores the page information successfully printed in the storage unit 20 at operation S174.

Lastly, the controller 30 stores the identification of the job in the storage unit 20 at operation S180.

As described above, an image forming apparatus and an image forming method according to the present general inventive concept determines whether inputted printing data is equivalent to printed printing data and does not form an image with the printed printing data, and prevents repetitive printing even if the printing data already used to form an image is requested again to form an image.

Also, the present general inventive concept provides an image forming apparatus and an image forming method which does not form an image with printed printing data and reduces consumption of the consumables such as record media and toner.

Also, the present general inventive concept provides an image forming apparatus and an image forming method which prevents inconvenience that a user individually controls printing data to prevent repetitive printing.

Further, the present general inventive concept provides an image forming apparatus and an image forming method which compares printing data even if the already-printed printing data does not include identification information, and prevents repetitive printing.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

Although a few exemplary embodiments of the present general inventive concept have been shown and described, it will be appreciated by those skilled in the art that changes may be made in these exemplary embodiments without departing from the principles and spirit of the general inventive concept, the scope of which is defined in the appended claims and their equivalents.

What is claimed is:

1. An image forming apparatus, comprising:
an image forming unit to form an image based on input printing data;
a storage unit to store history information of the printing data therein; and
a controller to determine whether the input printing data is already printed by using the history information, and to control the image forming unit not to form the image with the printing data already used to form the image among the input printing data if it is determined that the printing data is already printed.

2. The image forming apparatus of claim 1, wherein the controller determines whether the input printing data is already printed by comparing identification information of the printing data.

3. The image forming apparatus of claim 2, wherein the identification information comprises at least one of user information requesting to form the image, a file name of the printing data, a file size of the printing data, and succeeded/failed page information of the printing data regarding a printing operation of forming the image.

4. The image forming apparatus of claim 1, wherein the storage unit stores succeeded/failed printing data regarding a printing operation of forming the image, as the history information.

5. The image forming apparatus of claim 4, wherein the controller compares the input printing data with the failed printing data and determines whether the input printing data is already printed if the printing data does not include identification information.

6. The image forming apparatus of claim 4, wherein the controller generates a signal to display the printed page information among the failed printing data.

7. The image forming apparatus of claim 6, wherein the controller receives an input whether to print the failed printing data, and forms the image.

8. The image forming apparatus of claim 4, wherein the controller stores the history information of the printing data already used to form the image with a page unit in the storage unit.

9. The image forming apparatus of claim 1, wherein the controller stores the history information of the printing data already used to form the image with a page unit in the storage unit.

10. An image forming method, comprising:
storing history information on printing data;
determining whether the printing data is already printed by using the history information; and
controlling an image forming unit not to form an image with the printing data already used to form the image among input printing data if it is determined that the printing data is already printed.

11. The image forming method of claim 10, wherein the determining of whether the printing data is already printed comprises determining whether the printing data is already printed by using identification information of the printing data.

12. The image forming method of claim 11, wherein the identification information comprises at least one of user information requesting to form an image, a file name and a file size of the printing data, and succeeded/failed page information regarding a printing operation of forming the image

13. The image forming method of claim 10, wherein the storing of the history information comprises storing succeeded/failed printing data regarding a printing operation of forming the image.

14. The image forming method of claim 13, wherein the determining of whether the printing data is already printed comprises comparing the input printing data with the failed printing data and determining whether the input printing data is already printed if identification information of the printing data does not exist.

15. The image forming method of claim 14, wherein the determining of whether the inputted printing data is printed already further comprises displaying printed page information among the failed printing data.

16. The image forming method of claim 15, wherein the displaying of the printed page information further comprises receiving an input whether to print the failed printing data.

17. The image forming method of claim 13, wherein the storing of the history information comprises storing the information on the printing data already used to form the image with a page unit.

18. The image forming method of claim 10, wherein the storing of the history information comprises storing the information on the printing data already used to form the image with a page unit.

19. An image forming apparatus comprising:
an image forming unit to form an image on a print medium according to printing data; and
a controller to generate a signal representing history information of the printing data to correspond to a first portion of the printing data that is used to form the image and a second portion of the printing data that is not used to form the image, or to generate a signal representing history information of the printing data to correspond to the second portion of the printing data that is not used to form the image in a page unit.

20. An image forming apparatus, comprising:
an image forming unit to form a first image according to a first portion of printing data and not to form a second image according to a second portion of the printing data;
a storage unit to store history information of the printing data including first information on the first portion of the printing data and second information on the second portion of the printing data; and
a controller to determine whether information on input printing data to be formed as a third image is substantially same as the history information of the printing data, and to control the image forming unit not to form the first image with the first portion of the printing data and to form the second image according to the determination.

21. The image forming apparatus of claim 20, wherein:
the first image and the second image are formed in a page unit; and
the controller generates a signal representing the history information of the printing data in the page unit.

22. The image forming apparatus of claim 20, wherein the image forming unit renders the printing data to correspond to the first image and the second image in the page unit.

23. The image forming apparatus of claim 20, wherein the image forming unit renders the input printing data to correspond to the third image, and the controller determines whether the information of the third image of the input printing data is the same ad the history information of the first image and the second image of the printing data.
